(19) United States
(12) Patent Application Publication
(10) Pub. No.: US 2003/0024195 A1
(43) Pub. Date: Feb. 6, 2003

(54) Fitted magnetic panel

(76) Inventors: Jae H. Koh, Potomac, MD (US); Francis H. Koh, Potomac, MD (US); Henry H. Koh, Potomac, MD (US)

Correspondence Address: Francis Koh, 8811 Falls Rd., Potomac, MD, 20854, US

(21) Appl. No.: 09/922,623

(22) Filed: Aug. 6, 2001

(51) Int. Cl. B60R 13/04; B62D 25/00

(52) U.S. Cl. 52/506.01; 280/770; 40/600

(57) ABSTRACT

The presently disclosed invention claims fitted magnetic panels made of magnetic polymers which are shaped to fit over metal based body surfaces of automobiles and other mobile crafts. The fitted magnetic panel magnetically attaches to body surfaces and protects the surface from damage from the elements or from light to moderate collisions. Additionally the magnetic panels can be used to cover existing body surfaces that are damaged. The fitted magnetic panels can be shaped to various dimensions, colors, and designs.

### FIELD OF INVENTION

The invention relates to the field of magnetic panels fitted to cover specified metal based surfaces.

### BACKGROUND OF INVENTION

Automobiles and mobile crafts often have exposed body surfaces susceptible to damage from collisions with objects or damage resulting from natural elements such as harmful ultraviolet rays and acid rain. In particular, the side panels of cars are often dented and damaged during daily parking and driving. Damages on such panels can be costly to repair over a period of time. The presently claimed invention is directed at protecting such panels from damage.

### SUMMARY OF INVENTION

The presently claimed invention protects metal based body surfaces by covering them with fitted magnetic panels, shaped and cut to fit over the specified body surface dimensions. The fitted magnetic panel is composed of a flexible magnetic polymer which can be formed as a sheet and cut to fit specified dimensions or the flexible magnetic polymer can be cast molded to specified dimensions. Additionally the fitted magnetic polymer can be pigmented to desired colors or the fitted magnetic panel can be painted to desired colors and finishes. The flexible magnetic polymer can also be made of a glow in the dark polymer. The magnetic polymer can be formed as a unified blend or formed in polymeric layers. The fitted magnetic panels can be fitted to cover door surfaces, upper body surfaces, as well as spanning over glass surfaces to protect windshields from frost build up. Additionally., the fitted magnetic panel can cover existing damages on body surfaces. The color and appearance the fitted magnetic panel can be made to match the body surface making it difficult to discern the between the actual body surface and the fitted magnetic panel.

### DESCRIPTION OF FIGURES

FIG. 1: Shows a side view of the fitted magnetic panel over a metal based side panel of a car door.

FIG. 2: Shows the fitted magnetic panel over a flat bed surface of a conventional pick up truck.

FIG. 3: Shows the fitted magnetic panel spanning over the windshield.

FIG. 4: Shows the fitted magnetic panel placed over the surface of a car hood.

FIG. 5: Shows the fitted magnetic panel having channeled grooves on the surface thereby altering the aerodynamics of the car.

FIG. 6: Shows the fitted magnetic panel having glow-in-the-dark polymer.

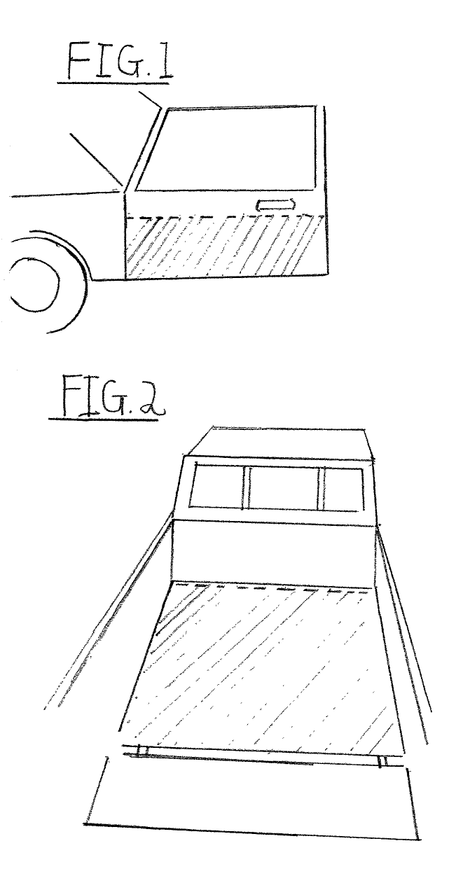

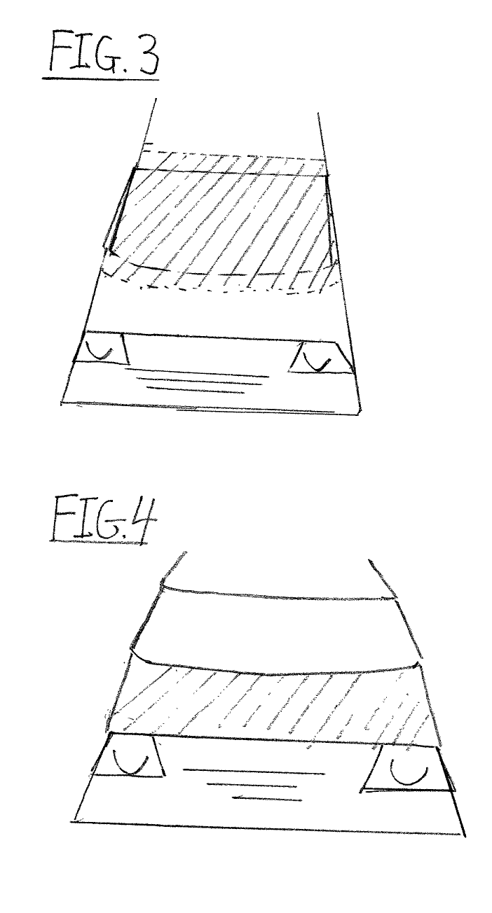

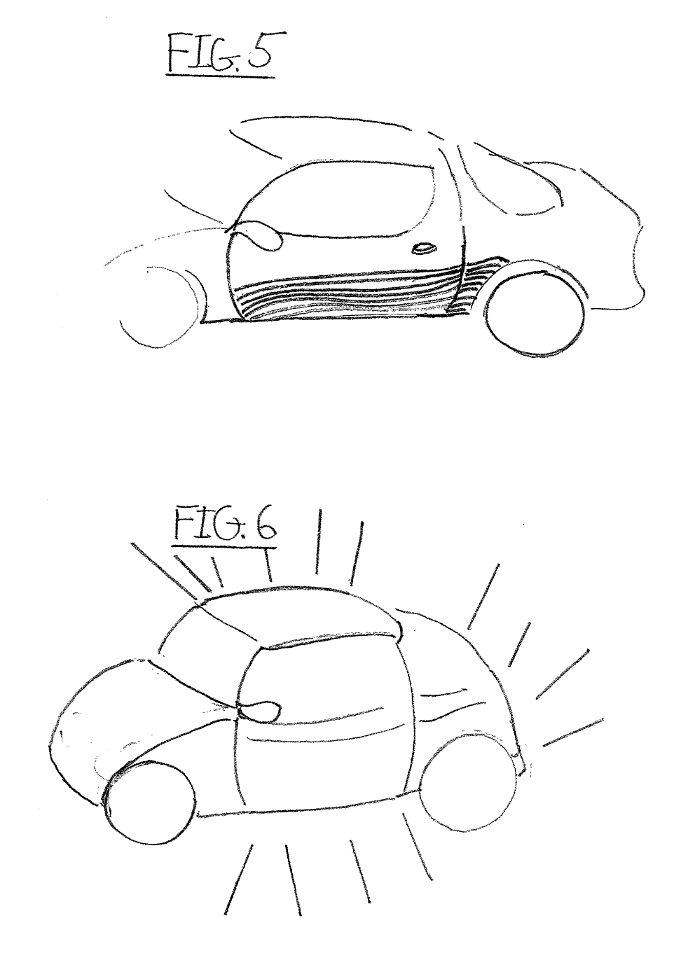

### DETAILED DESCRIPTION OF PREFERRED EMBODIMENTS OF THE INVENTION

In a preferred embodiment of the fitted magnetic panel, the magnetic panel comprises of a magnetic polymer. The magnetic polymer magnetically adheres to metal based surfaces. The magnetic polymer could also be pigmented to desired color specifications. Additionally, the magnetic polymer is shaped to fit metal based body surface dimensions. This fit can be achieved by any conventional shaping means such as machine cutting, laser cutting, heat induced shaping, and cast molding. Furthermore, the surface of the magnetic panel can be altered to feature channeled grooves that alter the aerodynamics when attached to the body surface of an automobile. The fitted magnetic panel is used to protect body surface from damage such as ordinary scratches, dings, and dents that result from contact with other doors in parking lots or from small stones and pellets. However, the fitted magnetic panel can also be used to conceal pre-existing dents and damages on body surfaces, serving as an alternative to repairing the body surface. The fitted magnetic panel can be used to create unique designs and patterns on automobiles. Such designs can be racing stripes, flames, animal patterns such as tiger stripes, cow patches, killer whale patches, etc. The fitted magnetic panel can have both a design and utility purpose.

In another preferred embodiment, the fitted magnetic panel comprises glow-in-the-dark polymer that makes the magnetic panel glow in the dark when attached to automobile surfaces.

In a certain preferred embodiment, the fitted magnetic panel comprises a reflective surface that reflects light.

In yet another preferred embodiment, the fitted magnetic panel spans over a windshield and magnetically attaches to metal surfaces on opposite sides of the windshield thereby holding the magnetic panel in place. This protects the windshield from frost build up in the winter.

Variations can be made to the fitted magnetic panel without defying the concept and scope of the following claims:

1. A fitted magnetic panel is magnetically attached to a metal based surface to protect the surface from damage.

2. The fitted magnetic panel of claim 1, wherein the magnetic panel is composed of flexible magnetic polymer that adheres to a magnetic surface.

3. The fitted magnetic panel of claim 2, wherein the magnetic polymer further comprises colored pigments.

4. The fitted magnetic panel of claim 2, wherein the magnetic polymer further comprises a glow-in-the-dark polymer.

5. The fitted magnetic panel of claim 2, wherein the magnetic polymer further comprises a reflective surface.

6. The fitted magnetic panel of claim 2, wherein the magnetic panel is shaped to fit over specified dimensions.

7. The fitted magnetic panel of claim 6, wherein the magnetic panel spans to cover glass surfaces while adhering to metal-based surface areas which keeps the magnetic panel in place.

8. A process of fitted magnetic panels wherein the magnetic polymer panels are formed to specified dimensions.

9. The process of fitted magnetic panels of claim 8, wherein the magnetic polymer panels are cast molded to specified dimensions.

10. The process of fitted magnetic panels of claim 8, wherein glow-in-the-dark polymers are blended with the magnetic polymer.

11. The process of fitted magnetic panels of claim 8, wherein the surface of the magnetic panel is glow in the dark or reflective to light.

12. The process of fitted magnetic panels of claim 8, wherein the magnetic panel is comprised of polymeric layers.
